(19) United States
(12) Patent Application Publication
(10) Pub. No.: US 2018/0147866 A1
(43) Pub. Date: May 31, 2018

(54) METHODS FOR REDUCING MEDIA SKEW IN MEDIA ADVANCE SYSTEMS AND MEDIA ADVANCE SYSTEMS

(71) Applicant: HEWLETT-PACKARD DEVELOPMENT COMPANY, L.P., Houston, TX (US)

(72) Inventors: Marta RAMIS LLINARES, Cerdanyola del Vallés (ES); Francisco Javier ROSES CONESA, Sant Quirze del Valles (ES); Eduardo MARTIN ORUE, Sant Quirze del Valles (ES)

(73) Assignee: Hewlett-Packard Development Company, L.P., Houston, TX (US)

(21) Appl. No.: 15/569,921

(22) PCT Filed: Jul. 31, 2015
(86) PCT No.: PCT/EP2015/067738

§ 371 Date: Oct. 27, 2017

(51) Int. Cl. B41J 15/04; B41J 11/66

(52) U.S. Cl. CPC B41J 15/046; B41J 11/663

(57) ABSTRACT

A method for reducing skew in a media advance system comprises advancing a media from a media roll (6a) through a feed roller (3) towards the nip of a drive roller (4); reducing a media transportation speed at the feed roller (3) relative to the media transportation speed at the drive roller (4) for a predetermined period of time when a leading edge of the media reaches the nip of the drive roller; and cutting the media to a predetermined page size at a position upstream of the feed roller.

### BACKGROUND

Media roll to single sheet printers cut the media from a roll into pages after the printing operation. This allows the control of both the back tension and the steering of the media while printing. For example by weight of the media roll (passive) or controlling the speed/torque of the media roll (active).

When new media is loaded into the input or drive rollers potential skew of the leading edge is addressed by means for alignment. Once loaded the back tension ensures alignment of the media and the print engine, e.g. drive rollers, through control of media advance direction and avoidance of media steering.

For high productivity systems, such as continuous printing devices, cut after printing consumes too much time, so cut before printing is desired. Thereto, a bubble i.e. excess of media is provided which allows a slow down or even a full stop of a portion of the media upstream of the bubble (and the printing operation) for cutting. The bubble or excess excludes the use of back tension control, as the media is not pulled on the media roll. Furthermore, as the media is cut before printing, a ‘new’ leading edge enters the drive roller, and repetitive alignment is needed.

Single page leading edge alignment assumes orthogonality between the leading edge and the lateral edge, which for pre-cut roll media does not hold. Similarly, when a complete new media roll is loaded orthogonality is assumed, but likewise this does not hold for cutting prior to printing.

### BRIEF DESCRIPTION OF THE DRAWINGS

The present disclosure will be illustrated by examples described in the following detailed description and in reference to the drawings, wherein:

FIG. 1 shows a cross-section of an example of a media advance system as implemented in a printer;

FIG. 2 shows a flow diagram of an example of a method to reduce media skew;

FIG. 3 shows a flow diagram of another example of a method to reduce media skew;

FIGS. 4a and 4b show a portion of the system of FIG. 1; and

FIG. 5 shows a flow diagram of yet another example of a method to reduce media skew.

### DETAILED DESCRIPTION

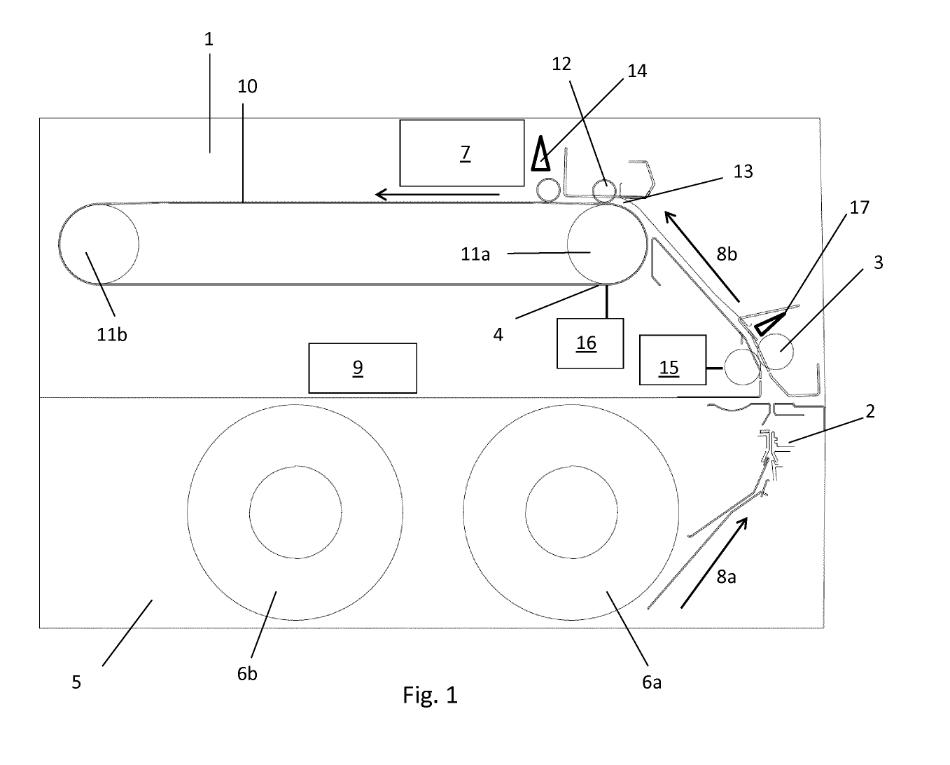

In FIG. 1 an example of a printer 1 having a media advance system therein is shown in cross-section. The media advance system comprises a cutter 2, a feed roller 3 and a drive roller 4. The printer 1 has a media roll tray 5 wherein, in this example, two media rolls 6a, 6b are stored. The media roll tray 5 is arranged for providing media on the media roll 6a to the feed roller 3. The printer 1 may further be equipped with a number of rollers, belts and guides to transport media from the media roll 6a to a printing engine 7 of the printer 1.

The feed roller 3, in this example comprising a pair of rollers, feeds the media from the media roll 6a to the drive roller 4. The drive roller 4, in this example comprising a pressure roller 12 and a belt 10 driven by two pulleys 11a,11b, is downstream of the feed roller 3 with regard to a media transportation direction as indicated by arrows 8a, 8b. A nip 13 of the drive roller 4 is formed between the belt 10 and the pressure roller 12. The cutter 2 is located upstream of the feed roller 3 and is arranged for cutting the media to a predetermined page size upstream of the feed roller 3.

In one example the media advance system further comprises an edge sensor 17 to sense a media leading edge passing through at the feed roller 3.

In one example the media advance system further comprises an edge sensor 14 to sense a media leading edge passing through at the drive roller 4.

The edge sensor 17 allows to determine the position of the leading edge when arriving at the feed roller 3. From thereon, the position of the leading edge may be determined by the distance that the media has been advanced by the feed roller 3, for example using an encoder of a motor used to drive the feed roller 3.

In one example the media advance system further comprises control logic 9 providing control of the media advance system, for example control of the feed roller 3 and drive roller 4.

According to one example, the control logic 9 reduces the media transportation speed at the feed roller 3 relative to the media transportation speed at the drive roller 4 for a predetermined period of time when a leading edge of the media reaches a nip 13 of the drive roller. Reducing the media transportation speed in this way, for a predetermined period of time, has the effect of reducing media skewing. In particular, the reduction of speed introduces a slippage of the media. If this is done just before the leading edge reaches the nip, both curling and skew of the media can be reduced. If it is done when the leading edge has passed through the nip, for example the leading edge is 10 to 20 mm after the nip, the effect of reducing skew is increased and the distance between consecutive media may be decreased allowing a higher throughput of media.

Furthermore, in one example the control logic 9 may activate the cutter 2. In addition, the control logic 9 may increase the media transportation speed at the feed roller 3 relative to the media transportation speed at the drive roller 4 for a predetermined period of time.

In one example the speed at which media is transported through the system i.e. the media transportation speed, is dependent on the operation of the feed roller 3 and the drive roller 4. For example, the rotational speed of the feed roller 3 determines the speed at which the media is fed towards to the drive roller 4. Similarly, the rotational speed of the drive roller 4 determines the speed at which the media is driven towards the printing engine 7.

Accordingly, the control logic 9 may reduce a rotational speed of the feed roller 3 relative to a rotational speed of the drive roller 4. Thereto, for example, the control logic 9 may reduce a speed of a feed motor 15 driving the feed roller 3 relative to a speed of a drive motor 16 driving the drive roller 4. In another example the control logic 9 may activate e.g. a brake system acting on the feed roller 3. In yet another example, the control logic may control a gear box as part of a drive system driving the feed roller 3 and/or the drive roller 4.

Furthermore, the control logic 9 may increase the rotational speed of the feed roller 3 relative to the rotational speed of the drive roller 4. Thereto, for example, the control logic 9 may increase the speed of the feed motor 15 driving the feed roller 3 relative to the speed of the drive motor 16 driving the drive roller 4.

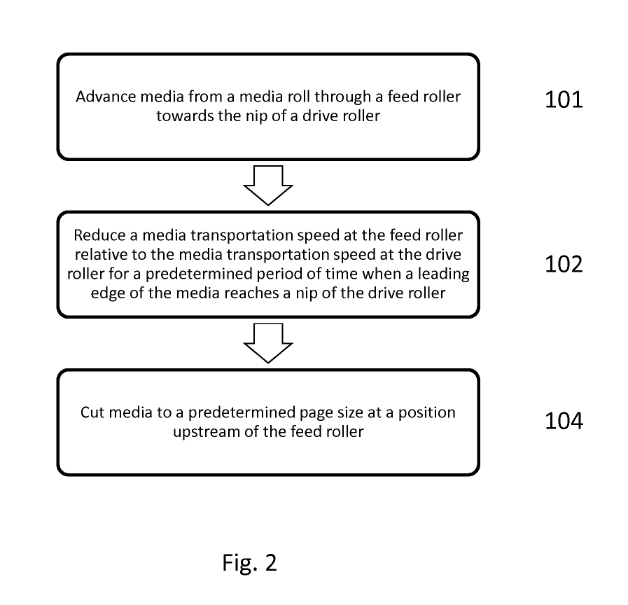

Turning to FIG. 2, a flow diagram of an example of a method to reduce media skew is shown. The method aims to reduce media skew in a media advance system by advancing 101 a media from a media roll 2 through the feed roller 3 towards the nip 13 of a drive roller 4, reducing 102 a media transportation speed at the feed roller 3 relative to the media transportation speed at the drive roller 4 for a predetermined period of time when a leading edge of the media reaches the nip 13 of the drive roller 4; and cutting 104 the media to a predetermined page size at a position upstream of the feed roller 3.

The reduction of the media transmission seed at the feed roller 3 affects the manner in which the leading edge of the media is gripped by the drive roller 4: a degree of slippage will occur. Applicant has found that when slippage occurs, the friction in the transversal direction is small, which allows skew i.e. misalignment of the media to be corrected. For example, a slippage of about 10-30 mm can be enough for a feeding skew of about 2-3 mm. After lapse of the predetermined period during which the media transportation speed was reduced at the feed roller 3 relative to the drive roller 4, the media transportation speed at both rollers 3, 4 may return to the same level. Thus, after alignment due to the slippage, the media will be transported through the system at one speed.

In one example, reducing the media transportation speed at the feed roller 3 relative to the media transportation speed at the drive roller 4 may be provided by reducing a rotational speed of the feed roller 3 relative to a rotational speed of the drive roller 4. In another example, reducing the rotational speed of the feed roller 3 relative to the rotational speed of the drive roller 4 may be provided by reducing a speed of a feed motor 15 driving the feed roller 3 relative to a speed of a drive motor 16 driving the drive roller 4. In another example, reducing the rotational speed of the feed roller 3 relative to the rotational speed of the drive roller 4 may be provided by applying a brake to the feed roller 3, or controlling a gear box which drives the feed roller 3.

In one example, reducing the media transportation speed at the feed roller 3 relative to the media transportation speed at the drive roller 4 may be provided by increasing a rotational speed of the drive roller 4 relative to a rotational speed of the feed roller 3. In another example, reducing the rotational speed of the feed roller 3 relative to the rotational speed of the drive roller 4 may be provided by increasing a speed of a drive motor 16 driving the drive roller 4 relative to a speed of a feed motor 15 driving the drive roller 4. In another example, reducing the rotational speed of the drive roller 4 relative to the rotational speed of the feed roller 3 may be provided by controlling a gear box which drives the drive roller 4.

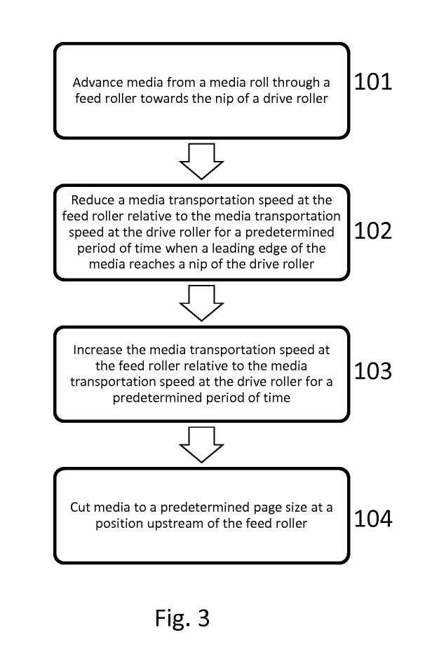

Turning to FIG. 3, a flow diagram of another example of a method to reduce media skew is shown. In addition to the example of FIG. 2, prior to cutting 104, the method comprises increasing 103 the media transportation speed at the feed roller 3 relative to the media transportation speed at the drive roller 4 for a predetermined period of time.

The increase in media transportation speed will create an excess of media in the path between the feed roller 3 and the drive roller 4; which may be noticed in the forming of a bulge or bubble. This bubble in turn, allows slowing down or even stopping the media upstream of the feed roller 3 at the location of the cutter 2 without hampering the further processing of the media downstream of the feed roller 3. The cutter 2 may then provide a clean cut of media. Hence, in one example, as part of cutting the media 104, the media transportation speed may be reduced or stopped at the position of the cutter 2.

In one example, increasing the media transportation speed at the feed roller 3 relative to the media transportation speed at the drive roller 4 may be provided by increasing a rotational speed of the feed roller 3 relative to a rotational speed of the drive roller 4. In a further example, increasing the rotational speed of the feed roller 3 relative to the rotational speed of the drive roller 4 may be provided by increasing a speed of a feed motor 15 driving the feed roller 3 relative to a speed of a drive motor 16 driving the drive roller 4.

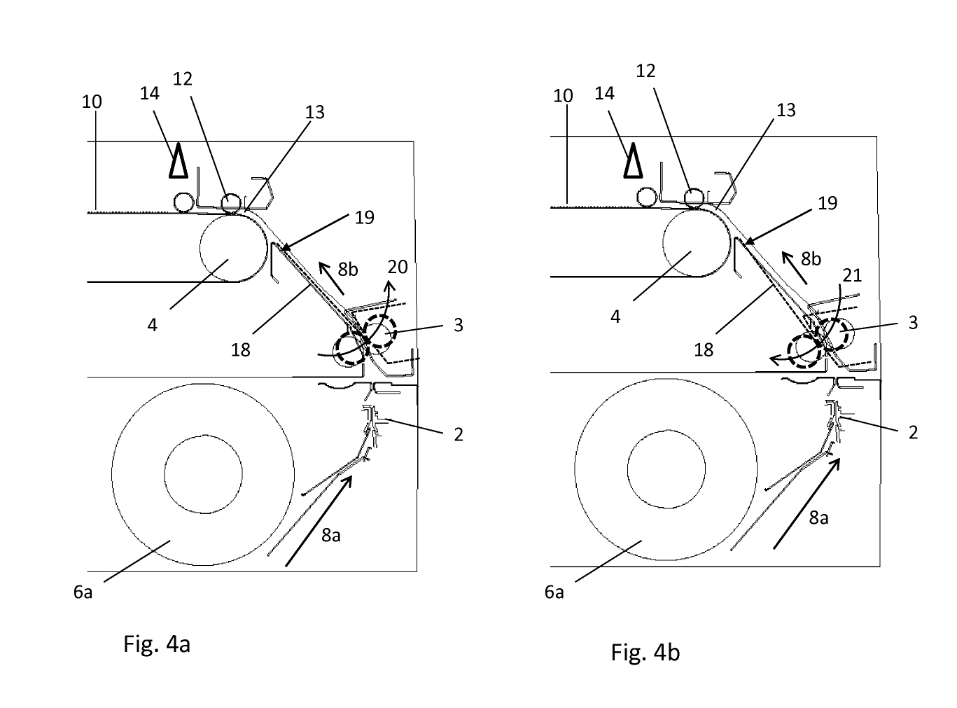

Referring to FIGS. 4a and 4b, showing a part of the system of FIG. 1, these illustrate how a feed roller lever 18 may be moved upwards and/or downwards relative to a fixed fulcrum point 19. As indicated by arrows 20, 21 movement of the lever 18 provides rotational movement of the feed roller 3 about fulcrum 19 in counter-clockwise or clockwise fashion. Thus, the feed roller may be moved relative to the drive roller 4 in a direction orthogonal to the media transportation direction 8b. This movement provides adjustment of the media path length by moving the feed roller 3 relative to the drive roller 4. The effect thereof is that the skew at the drive roller 3 may be reduced.

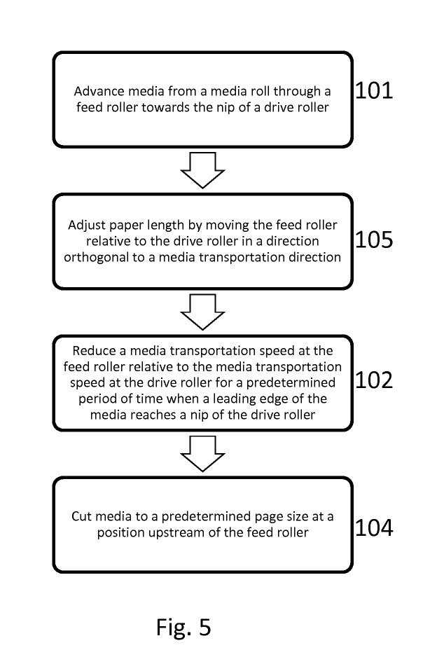

Turning to FIG. 5, a flow diagram of another example of a method to reduce media skew is shown. In addition to the example of FIG. 2, prior to reducing the speed of the feed roller 3 relative to the speed of the drive roller 4, the method comprises adjusting 105 the media path length by moving the feed roller 3 relative to the drive roller 4 in a direction orthogonal to a media transportation direction. The consecutive stages of adjusting media path length and reducing relative speed alleviate media skew in the media advance system 1.

The examples described above can help reduce skew caused by feeding skew due to angles, and variations on the media path length from one side to another. The examples can also help reduce skew caused by variability in the angle of the leading edge arriving to the drive system, for example because of media stiffness, media curling, and so on.

In the foregoing description, numerous details are set forth to provide an understanding of the examples disclosed herein. However, it will be understood that the examples may be practiced without these details. While a limited number of examples have been disclosed, numerous modifications and variations therefrom are contemplated. It is intended that the appended claims cover such modifications and variations

1. A method for reducing media skew in a media advance system, comprising:
advancing a media from a media roll through a feed roller towards the nip of a drive roller;
reducing a media transportation speed at the feed roller relative to the media transportation speed at the drive roller for a predetermined period of time when a leading edge of the media reaches the nip of the drive roller; and
cutting the media to a predetermined page size at a position upstream of the feed roller.

2. A method according claim 1, wherein reducing a media transportation speed at the feed roller relative to the media transportation speed at the drive roller comprises:
reducing a rotational speed of the feed roller relative to a rotational speed of the drive roller; or
increasing a rotational speed of the drive roller relative to a rotational speed of the feed roller.

3. A method according to claim 2, wherein reducing the rotational speed of the feed roller relative to the rotational speed of the drive roller comprises:
reducing a speed of a feed motor driving the feed roller relative to a speed of a drive motor driving the drive roller; or
activating a brake system acting on the feed roller; or
controlling a gear box forming part of a drive system driving the feed roller and/or the drive roller.

4. A method according to claim 2, wherein increasing the rotational speed of the drive roller relative to the rotational speed of the feed roller comprises:
increasing a speed of a feed motor driving the drive roller relative to a speed of a feed motor driving the drive roller; or
controlling a gear box forming part of a drive system driving the drive roller and/or the feed roller.

5. A method according to claim 1, further comprising:
prior to cutting, increasing the media transportation speed at the feed roller relative to the media transportation speed at the drive roller for a predetermined period of time.

6. A method according to claim 5, wherein increasing the media transportation speed at the feed roller relative to the media transportation speed at the drive roller comprises:
increasing a rotational speed of the feed roller relative to a rotational speed of the drive roller.

7. A method according to claim 1, further comprising:
adjusting the media path length by moving the feed roller relative to the drive roller in a direction orthogonal to a media transportation direction.

8. A media advance system, comprising:
a feed roller;
a drive roller arranged downstream of the feed roller;
a cutter to cut media upstream of feed roller; and
control logic to reduce a media transportation speed at the feed roller relative to the media transportation speed at the drive roller for a predetermined period of time when a leading edge of the media reaches a nip of the drive roller.

9. A system according to claim 8, wherein the control logic reduces a rotational speed of the feed roller relative to a rotational speed of the drive roller; or reduces a speed of a feed motor driving the feed roller relative to a speed of a drive motor driving the drive roller.

10. A system according to claim 8, further comprising:
an edge sensor to sense a media leading edge arriving at the drive roller.

11. A system according to claim 8, wherein the control logic increases the media transportation speed at the feed roller relative to the media transportation speed at the drive roller for a predetermined period of time.

12. A system according to claim 8, wherein the control logic activates the cutter.

13. A system according to claim 8, comprising:
an adjustment system to adjust a media path length by moving the feed roller relative to the drive roller in a direction orthogonal to a media transportation direction.

14. A printer, comprising a system according to claim 8.

15. A printer according to claim 14, further comprising:
a media roll container to hold a media roll and provide media on the media roll to the feed roller.
